(19) United States
(12) Patent Application Publication
(10) Pub. No.: US 2007/0246408 A1
(43) Pub. Date: Oct. 25, 2007

(54) Filter System

(76) Inventors: Martin Eurlings, Bilzen (BE); Philippe Albert, Theux (BE); Stefan Vandendijk, Tongeren (BE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/666,149

(22) PCT Filed: Oct. 26, 2005
(86) PCT No.: PCT/EP05/55576

§ 371 Date: Apr. 24, 2007

(30) Foreign Application Priority Data
Oct. 27, 2004 (EP) 04077962.1

(51) Int. Cl. B01D 29/66

(52) U.S. Cl. 210/108

(57) ABSTRACT

Filter system comprising a back-flush unit (B) provided to back-flush said filter unit (F). The filter unit (F) has at least a housing (3) and at least a first filter element (1) separating a raw material compartment (34) from a filtrate compartment (35). The filter unit (F) has a first filtrate outlet (6) and is in communication with the filtrate compartment (35). The back-flush unit (B) comprises a first expansion vessel (17). The filter system also comprises pressurising means (11,12,13,23) to pressurise the filtrate when in the second compartment. The filter unit (F) also comprises a second filtrate outlet (7) different and spaceded apart from said first filtrate outlet (6). The first filtrate outlet (6) is in communication with the filtrate outlet (6). The first filtrate outlet (6) is in communication with the filtrate compartment (35) and with the expansion vessel (17) by means of a first back-flush nozzle (29).

The present invention relates to a filter system comprising a back-flush unit connected to a filter unit, said back-flush unit being provided to back-flush said filter unit,
said filter unit being provided to filter a raw material comprising particles in suspension or in solution in a fluid, said filter unit having at least a housing and at least a first filter element located inside said housing, said first filter element separating a raw material compartment from at least a first filtrate compartment; both compartments being inside said housing, said filter unit further having a raw material inlet in communication with said raw material compartment and at least a first filtrate outlet provided to exit a filtrate, said first filtrate outlet being in communication with said first filtrate compartment,
said back-flush unit comprising at least a first expansion vessel with a diaphragm provided to divide said expansion vessel into a first compartment and a second compartment, said first compartment being provided to contain a compressible medium, said second compartment being provided to contain said filtrate,
said filter system comprising pressurising means provided to pressurise the filtrate when in the second compartment.

Generally filter systems comprising a back-flush unit are provided to clean a filter unit and to remove the particles which are accumulated on the surface of the filter element during the filtration operation of the filter. The accumulation of the particles is generally caused by the flow rate direction of the raw material passing through the filter unit. The back-flush operation generally consists in an inversion of the flow rate direction to exert an opposite force on the particles and therefore, those particles are removed from the surface of the filter element. The back-flush operation is generally done by using the filtrate.

Several types of filter systems with a back-flush unit for cleaning a filter unit are known. The key feature of these systems is the pressurisation of the filtrate in the expansion vessel.

One common type of filter systems with a back-flush unit for cleaning a filter unit known to this date comprises a buffer vessel with filtrate which is pressurised with compressed air or another gas.

A further known common type of back-flush device comprises a pump situated after the filter elements that pumps the filtrate back in reverse direction.

Such back-flush devices using pressurisation or pumping are discontinuous devices which do not allow a continuous process to be carried out therein. They are further complicated and require a cumbersome maintenance.

For example, US 2003/0042184 describes a filter system with a back-flush unit for cleaning a filter unit as described by the preamble of claim 1. Moreover, the filter unit of this system comprises a filtrate outlet connected to a three-way connector, the first end of the three way connector is connected to the filter unit, the second end of the connector is connected to the second compartment of the expansion vessel by a connection comprising a valve and the third end of the connector is connected to a filtrate harvesting nozzle also comprising a valve. The harvesting nozzle comprises a lateral tube between the connector and the valve to connect the filtrate outlet to a pump, which pump is on its turn connected to the second compartment of the expansion vessel. The connection between the filtrate harvesting nozzle and the pump also comprises a valve.

Therefore, when the filter unit is in filtration operation, the filtrate exits the filter unit through the filtrate outlet and the harvesting nozzle for its harvest. The valves of the connections are both closed and the valve of the harvesting nozzle is open. When the filtrate has to go in the expansion vessel to store an amount of filtrate to be used for the back-flushing, the valve of the connection between the pump and the lateral tube is open and the other two valves are closed. This allows the pump to pump the filtrate in order to fill the expansion vessel and allows the filtrate located in the expansion vessel to be pressurised by the pump.

When the filter unit has to be back-flushed, the filtrate contained in the second compartment of the back-flush device returns to the filter unit, said filtrate being ejected from the expansion vessel due to the accumulated pressure by the pump. For this back-flushing operation, the valve between the filtrate outlet and the expansion vessel is open and the other two valves are closed.

Unfortunately, the filter system with a back-flush unit for cleaning a filter unit according to US 2003/0042184 is a discontinuous system, i.e. the filtration operation has to be stopped during the back-flush operation. Indeed, when back-flushed, the sedimented particles on the surface of the filter are removed and washed away by the filtrate in order to leave the filter unit through a waste outlet. Therefore, the filter unit has to be stopped because if it is not the case, all raw material entering by the raw material inlet is directly exited by the waste outlet without being filtered. Generally, the raw material to be filtered contains a substance of interest being either the fluid in which the particles are in suspension or the particles themselves. In both cases, the direct exit of the raw material consists in a reduced yield having a cost consequence. Therefore, this results in a loss of productivity and yield of the filter system.

Another example can be found in DE 198 10 518. DE 198 10 518 mainly describes two embodiments of a filter system with a back-flush unit for cleaning a filter unit. In the first embodiment, The filter unit has a raw material inlet and a filtrate outlet. The filtrate outlet is connected to a three way connector. The first end of the three way connector is connected to the filtrate outlet, the second end is connected to a filtrate tank by a connection comprising an open-closed valve and the third end is connected to the second compartment of the expansion vessel. The raw material inlet is connected to a multidirectional valve either allowing the raw material to enter from a raw material tank into the filter unit through a pump or allowing the raw material to enter into the first compartment of the expansion vessel or even allowing a waste fluid to exit the filter unit to a waste tank.

When the filter unit of DE 198 10 518 is in filtration operation, the filtrate exits the filter unit through the filtrate outlet. If the valve between the filtrate tank and the filtrate outlet is open, the filtrate is harvested in the tank. If this valve is closed, the filtrate feeds the second compartment of the expansion vessel. When the second compartment is filled with filtrate and when the filter unit has to be back flushed, the valve between the filtrate outlet and the filtrate tank is closed forcing the filtrate to enter the filter unit by the filtrate outlet. At the same moment, the pump exhausts the raw material and the multidirectional valve is in a position such to allow the raw material to enter into the first compartment. This raw material exerts a pressure on the diaphragm and pushes out the filtrate to force it to enter into the filter unit. Therefore, the sedimented particles on the surface of the filter are removed and washed away by the filtrate in order to leave the filter unit through a waste outlet and arrive into the waste tank.

In this embodiment, the raw material does not exit directly by the waste outlet thanks to the multidirectional valve and therefore, the loss of raw material is reduced but such multidirectional valve are costly and fragile having a heavy wear. Moreover, in this back-flush unit, the pressure exerted on the filtrate contained in the second compartment of the expansion vessel is not enough to create a high pressure rapid burst of back-flush filtrate and the particles are not efficiently removed from the surface of the filter. Further, the system is discontinuous resulting in a loss of yield of the filtration operation by the stop of the filter unit and by the ejection of an amount of filtrate comprising the clogging particles in a waste tank. Indeed, when the filter unit is in back-flush operation, the filtration operation is stopped because the pump feeds the expansion vessel with the raw material and not the filter unit and the multidirectional valve directs the waste fluid to the waste tank and the raw material in the expansion vessel.

The second embodiment of DE 198 10 518 comprises two expansion vessels. The first compartment of both expansion vessels are provided to contain a compressible medium as a difference from the first embodiment. Both expansion vessels are placed in series and the second expansion vessel seems to act as “a flow rate carrier”. The operation is the same as before and therefore presents the same problems and disadvantages than the first embodiment.

Another filter system with a back-flush unit for cleaning a filter unit is known from US 2003/0019800 which describes a filter system also as described by the preamble of claim 1. In this system, the filtrate outlet is connected to other filters placed in series and amongst them an expansion vessel is placed. A valve is just placed after the back-flush device. In other words, the filtrate exits the filter, enters another filter, exits this filter, enters in the expansion vessel, exits the expansion vessel, passes through the valve if opened, enters another filter, exits this other filter, etc to reach for example a filtrate tank. If this valve is closed, the pressure of the filtrate in the expansion vessel increases by compressing the compressible medium present in the first compartment of the expansion vessel. When the back-flush of the filter is done, several valves are utilised to interrupt normal fluid flow and therefore, the expansion vessel creates a reverse flow through the filter to remove the sedimented particles.

Unfortunately, the filtration operation has also to be stopped during the back-flush of the filter thereby resulting in a reduced yield of the filter.

Indeed, the flow rate direction is completely inverted in the filtrate operation and in the back-flush operation, and the fact of not stopping the filtration operation will have as a result a high overpressure by having two opposite flow rate exerting a force on each other and this will have as a result the non flushing of the filter unit.

Other filter systems are known, for example from U.S. Pat. No. 5,234,605, DE 28 31 607, but no described systems are continuous systems allowing a back-flush during the filtration operation.

A continuous system is known from FR 2 716 385 which describes a system comprising a plurality of separate filter units. During the back-flushing of one filter unit, the others are still in filtration operation and they are back-flushed each on their turn. Therefore, it can not be considered that the system is a continuous one because when a filter unit of the plurality of filter unit is in back-flush operation, it can not be simultaneously in filtration operation. The system is rather a juxtaposition of several systems for having at least one in filtration operation during the back-flush of the other.

It is therefore an object of the invention to palliate at least some of these drawbacks by providing a device which can be used without interruption when cleaning should be done, more easy to carry out and to use and which does not require a cumbersome maintenance.

To this end, the invention provides a filter system according to the preamble of claim 1, characterised in that said filter unit further comprises a second filtrate outlet provided to exit said filtrate, said second filtrate outlet being different and spaced apart from said first filtrate outlet, said first filtrate outlet being in communication with said filtrate compartment and with the second compartment of the expansion vessel by means of a first back-flush nozzle, and in that said pressurising means are provided to induce a flow rate variation of the filtrate flow rate in said first filtrate compartment.

This allows the filter unit to continue its filtration operation during the back-flush. Indeed, the co-operation between the effect of the pressurising means which induce a variation of the flow rate of the filtrate in the filtrate compartment and therefore, which does not stop the flow rate of the filtrate and the effect of the presence of a second filtrate outlet, allowing the filtrate to exit the filter unit even during the back-flush of the filter unit allow simultaneous filtration and back-flush without the need of additional filter units such as in FR 2 716 385.

In more details, the pressurising means has two combined effect in all steps. During the step of filtration while filling the expansion vessel, the first effect is that when the flow rate of the filtrate in the filtrate compartment undergoes a variation being an increase or a decrease of the flow rate, depending on the type of the filter unit, the pressure of the filtrate in the filtrate compartment increases and the filtrate fills the second compartment of the expansion vessel. The other effect is that since the flow rate of the filtrate in the filtrate compartment is not stopped, the filtrate continues to exit the filter unit and the filter unit continues its filtration operation.

During the back-flush steps, the flow rate of the filtrate undergoes another variation being respectively a decrease or an increase of the flow rate, depending on the variation applied during the preceding step.

For example, the raw material flow rate at an outlet of the filter unit can abruptly increase, therefore, a drawdown in the raw material compartment is created, forcing the filtrate contained in the filtrate compartment to pass from the filtrate side of the filter element to the raw material side of the filter unit. Hence, the filtrate contained in the second compartment of the expansion vessel counterbalances the abrupt pressure decrease to re-equilibrate the pressure in the filtrate compartment and in the raw material compartment. By the balancing of the pressure of the filtrate compartment, the filtrate contained in the second compartment back-flushes the filter unit and the sedimented particles are removed from the surface of the filter. As there is another filtrate outlet which is partially obstructed either by a throttle valve or another plant installation, or even a pump, and as the filtrate flow rate does not stop, the filtrate continues to exit the filter unit and the filtration operation continues.

Moreover, the pressurisation of the filtrate in the second compartment of the expansion vessel when filling this lafter, enables to give to the filtrate contained therein a sufficient work to have a very efficient back-flush effect and a high pressure rapid burst of back-flush filtrate is created.

This is due to the fact that the pressurising means are acting either on the filtrate flow rate or on the raw material flow rate or even on both and to the fact that the first compartment of the expansion vessel contains a compressible medium and not a liquid which is non compressible.

Advantageously, the pressurising means are provided to act at said second filtrate outlet in order to reduce said filtrate flow rate at said second filtrate outlet for filling the expansion vessel.

In a similar way, the pressurising means are provided to act at the raw material inlet in order to induce a raw material flow rate variation inducing said filtrate flow rate variation.

In a preferred embodiment, the pressurising means are provided to act at an outlet of the filter unit, said outlet being a waste outlet or a concentrate outlet in order to induce a raw material flow rate variation inducing said filtrate flow rate variation.

For example, the pressurising means acting on the filtrate flow rate can be a pump situated at the filtrate outlet. The pump can induce a flow rate diminution at the filtrate outlet by partially obstructing the filtrate outlet, causing an overpressure in the filtrate compartment forcing the filtrate to fill the second compartment of the expansion vessel.

When back-flush is needed, a pump situated at the waste or concentrate outlet can induced an abrupt flow rate increasing at the outlet causing an abrupt pressure reduction in the raw material compartment forcing the filtrate contained in the filtrate compartment and therefore in the expansion vessel to equilibrate the drawdown and therefore to back-flush the filter unit. As the pump does not stop, the flow rate of the filtrate is different from the zero value and the filtration operation is still maintained.

The pressurising means can also be a throttle valve acting at the filtrate outlet by obstructing partially this lafter and inducing the filling of the second compartment of the expansion vessel, as aforementioned and a pump situated at the raw material inlet. When a back-flush operation is needed, the flow rate of the pump is decreased thereby causing a drawdown in the raw material compartment which will be equilibrated by the filtrate contained in the filtrate compartment and therefore in the expansion vessel. Hence, the filter unit will be back-flushed.

The pressurising means can also be a throttle valve placed at the waste or concentrate outlet. The throttle valve can reduce or increase the size of the outlet orifice. Therefore, if the size of the outlet orifice is decreased, the pressure in the raw material compartment increases causing an overpressure in the filtrate compartment which will induce the filling of the second compartment of the expansion vessel. When returning to the initial size or to a greater size of the outlet orifice, this will cause an abrupt drawdown at the waste or concentrate outlet causing a reduction of the pressure in the raw material compartment and then in the filtrate compartment which will be equilibrated by the filtrate contained in the second compartment of the expansion vessel and the filter unit will be back-flushed.

The pressurising means can also be a pump placed at the raw material inlet. Therefore, an increase of the flow rate of the raw material will cause an increase of the pressure in the raw material compartment and of the filtrate flow rate in the filtrate compartment since the outlet flow rate will be the same. Therefore, this will cause the filling of the second compartment of the expansion vessel. When returning to the initial flow rate of the raw material inlet, this will cause an abrupt pressure reduction in the raw material compartment and then in the filtrate compartment which will be equilibrated by the filtrate contained in the second compartment of the expansion vessel and the filter unit will be back-flushed.

As mentioned before, all combination of the pressurising means are possible. For example, a pump can be present at the raw material inlet and a throttle valve can be present at the filtrate outlet, both pump and throttle valve being used as pressurising means or a throttle valve or a pump can be present both at the waste or concentrate outlet and at the second filtrate outlet, or even in some case, if the second filtrate outlet is partially obstructed by a downstream plant installation, a pump situated at the raw material inlet can be sufficient.

In summary, if the flow rate at the raw material inlet is F1, the flow rate at the second filtrate outlet is F2 and the flow rate at the waste or concentrate outlet is F3, it is preferred to have the following relationship between this flow rates:

When filling the expansion vessel, F2<F1 or F3<F1

When back-flushing the filter unit, F1<F3 and F2<F1.

In a very preferred embodiment, the first filtrate outlet is provided upstream the second filtrate outlet in view of a filtrate direction when the filter unit is in filtration operation.

In this embodiment, during the back-flush, the filtration operation and the back-flush operation both have the same direction of flow rate and not two opposite flow rate exerting a force on each other and therefore, the flushing effect of the filter unit of the system according to the invention is increased.

According to one embodiment of the invention, the filter unit is a cross flow filter unit having a concentrate outlet. The cross flow filter units, as it is known from the person skilled in the art has always a concentrate outlet. In some case, the concentrate is directly harvested at the concentrate outlet and in some cases, the concentrate is recirculated in the filter unit to increase the concentration effect.

The filter of the filter system can be a dead end filter unit. Generally, such dead end filters have only a filtrate outlet and no concentrate outlet. Several dead end filters comprise a waste outlet for removing the clogged particles, but in other dead end filters, the filter has to be disassembled for removing the clogged particles. The invention intends to be applied to both types of dead end filter units, i.e. during the back-flush step of the filter unit, in one case, the particles can be removed during the filtration operation and in the other case, the particles are maintained in the raw material compartment, but still without stopping the filtration operation.

Preferably, said filter unit comprises a waste outlet provided with a valve, said waste outlet being provided to remove the particles having a size greater of said predetermined pore size remaining in the raw material compartment when or after back-flushing of the filter unit.

Therefore, the removing of the particles clogged can also be done during the filtration without leaving them in the raw material compartment.

In a preferred embodiment, the filter system according to the invention comprises
a second filter element installed concentrically inside said first filter element in the filter unit and separating the raw material compartment from a second filtrate compartment being connected to said second filtrate outlet,
a second expansion vessel with a diaphragm provided to divide said second expansion vessel into a first compartment and a second compartment, said first compartment being provided to contain a compressible medium, said second compartment being provided to contain said filtrate, said second compartment of said second expansion vessel being provided to be connected to said second filtrate outlet by means of a second back-flush nozzle
a first filtrate harvesting nozzle connected to the first filtrate outlet, and being in communication with both first and second back-flush nozzle respectively by means of a first communication nozzle and of a second communication nozzle, both first and second communication nozzles comprising a valve.

In this preferred embodiment, two filter elements are provided, having both their own filtrate outlets. Each filtrate outlet is connected to its own expansion vessel by means of a communication nozzle comprising a valve and both filtrate outlets are also connected to a single filtrate harvesting nozzle. Therefore, the filter system is a continuous system allowing a continuous filtration process to be carried out in the filter unit when a cleaning step is needed. Indeed, when acting on the pressurising means, for example on a pump placed at the raw material inlet, it is possible to increase the flow rates in the compartments of the filter and thus to fill the expansion vessel with filtrate.

When starting the system and when starting the filtration operation, both valves of the communication nozzles are in open position to allow the filtrate for filling the expansion vessel. When the level of filtrate in the expansion vessel is sufficient, the valves in open position have to be closed. Then the filtration operation normally continues and the filtrate is harvested at the first filtrate harvesting nozzle.

When the filter unit is clogged or showing deposits, the valve of the first or of the second communication nozzle will be opened to clean the surface of the first or of the second filter element while respectively the valve of the second or the first communication nozzle is in closed position allowing the filter unit to continuously operate.

Because the expansion vessel is connected by means of two back-flush nozzles and by means of two communication nozzles to the two filtrate outlets and therefore to the two filtrate compartments of the filter unit, when a filter has to be cleaned, it can be in a cleaning cycle while the other remaining in use.

In another preferred embodiment, the filter system according to the invention comprises
a second filter element installed concentrically inside said first filter element in the filter unit and separating the raw material compartment from a second filtrate compartment being connected to said second filtrate outlet,
a second expansion vessel with a diaphragm provided to divide said second expansion vessel into a first compartment and a second compartment, said first compartment being provided to contain a compressible medium, said second compartment being provided to contain said filtrate, said second compartment of said second expansion vessel being provided to be connected to said second filtrate outlet by means of a second back-flush nozzle connected to the second compartment of the expansion vessel by means of a second back-flush nozzle.
a first filtrate harvesting nozzle connected to the first filtrate outlet, and being in communication with the first back-flush nozzle
a second filtrate harvesting nozzle connected to the second back-flush nozzle and to the second filtrate outlet.

In this other preferred embodiment, two separate expansion vessels and two separate harvesting nozzles are provided. Therefore, each filter element has its own expansion vessel and its own filtrate harvesting nozzle, both being connected to its filtrate outlet.

The same advantages as aforementioned are provided, i.e. the continuous filtration operation even when a back-flush operation is provided. However, the use of valves is not needed since no pieces of the system are splifted. This can be advantageous in some application, for example when the cut off of both filter elements is not the same and therefore when the filtrate quality at the first and the second outlet is not the same. Moreover the fact that no valves are needed reduces the wear of the device thereby increasing the life time of the system and avoiding the replacement of such fragile pieces.

In another variant particularly preferred, the filter system according to the invention comprises
a second filter element installed concentrically inside said first filter element in the filter unit and separating the raw material compartment from a second filtrate compartment being connected to said second filtrate outlet,
a first filtrate harvesting nozzle connected to the first filtrate outlet, and being in communication with the first back-flush nozzle by means of a first communication nozzle,
a second communication nozzle connected to said second filtrate outlet and to the second compartment of the first expansion vessel by means of the first back-flush nozzle, both first and second communication nozzle comprising a valve, and
a second filtrate harvesting nozzle connected to said second filtrate outlet and to said second communication nozzle.

In this other variant, the same advantages as aforementioned are provided, i.e. the continuous filtration operation even when a back-flush operation is provided. However, the use of only one expansion vessel reduce the cost of the device and avoid the use of a lot of nozzles which could be interverted by a user when mounting the system according to the invention. Therefore a particularly simple-to-use and low cost system is provided.

Advantageously, the second communication nozzle is connected to said second compartment of said expansion vessel by means of a second back-flush nozzle.

Preferably, the first filtrate harvesting nozzle also comprises pressurising means, being in particular a first throttle valve.

When the first filter element is in back-flush operation, it can be advantageous to be able to reduce or to close the first filtrate harvesting nozzle. Particularly, when another plant is provided downstream the filtrate harvesting nozzle and connected to this lafter, it can be advantageous to not stop the filtrate flow rate in order to not stop the downstream plant.

More preferably, the second filtrate harvesting nozzle also comprises the pressurising means, being in particular a second throttle valve and most preferably, both filtrate harvesting nozzle comprise such a pressurising means.

This can be advantageous to have the same advantages as aforementioned also at the second filtrate harvesting nozzle or at both filtrate harvesting nozzles.

Of course, a pump can also be used at those filtrate harvesting nozzles instead of the throttle valve as pressurising means.

Advantageously, the pressurising means of the first and the second filtrate harvesting nozzles are separately controlled. In a similar way, the valve of the first and the second communication nozzles are separately controlled.

Advantageously, the concentrate outlet is connected to the raw material inlet, increasing the concentration effect of the filter unit.

Advantageously, the concentrate outlet is provided with a valve, in particular with a throttle valve.

The throttle valve at the concentrate outlet can be interesting when the flow rate of the concentrate has also to vary, for example, when the amount of clogged particles is very high. Therefore, an increase of the flow rate caused by opening the throttle valve in the raw material compartment can help and contribute to the removing of the clogged particles by exerting a increased force upon this clogged particles (higher flow speed in raw material compartment 34). In other case, when the filter is not clogged and when the expansion vessel has to be filled with filtrate, a decreasing of the flow rate (closing throttle valve) will increase the pressure upon the filtrate and will contribute to the filling of the expansion vessel by forcing the filtration of the raw material and therefore by increasing the pressure of the filtrate compartment. In another situation, the throttle valve can be closed. Therefore, it allows to use the cross flow filter unit as a dead end filter unit by making only one cost investment.

In a preferred embodiment, the raw material inlet comprises a three-way-connecting means having a first end, a second end and a third end, the first end being connected to the filter unit and the second end being connected to a raw material tank.

When the concentrate is returning into the filter unit, such a three way connecting means can be very advantageous. Indeed, the raw material is mixed with the concentrate before entering the filter unit.

In one embodiment, the pump comprises the three-way-connecting means, and in another embodiment, the pump is connected to the first end of the three-way-connecting means.

In a variant, the third end is connected to a concentrate draw off outlet. This outlet allows to collect the concentrate when it is for example too viscous or enough concentrated.

Other embodiments of the system according to the invention are mentioned in the annexed claims.

Other characteristics and advantages of the invention will appear more clearly in the light of the following description of a particular non-limiting embodiment of the invention, while referring to the figures.

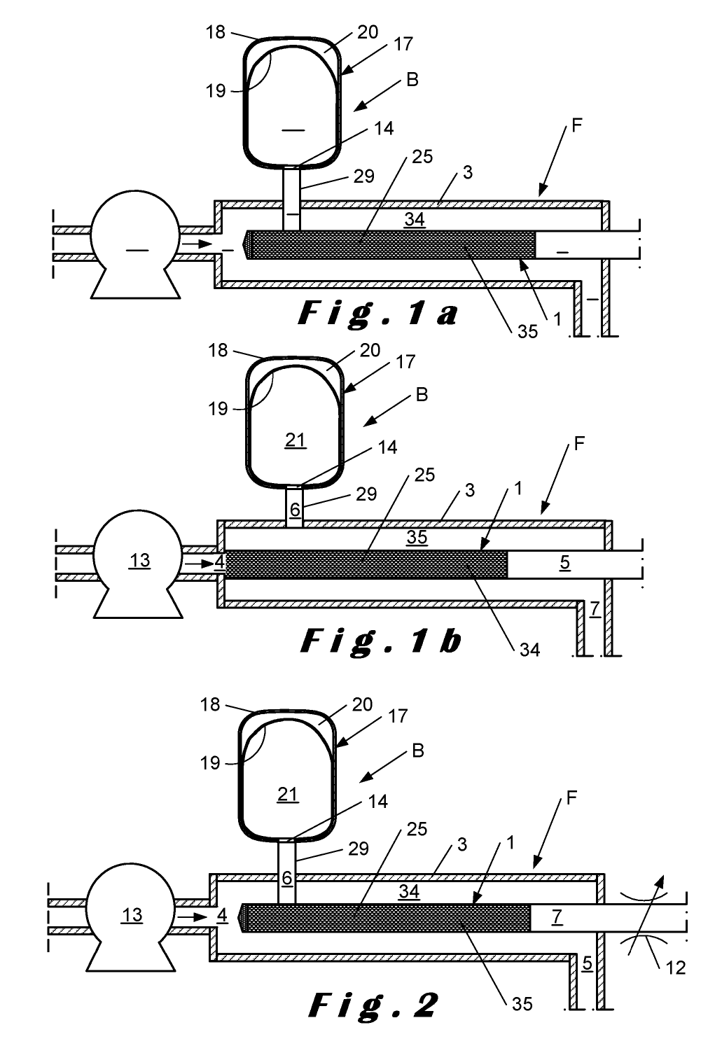

FIG. 1a is a cross section of an embodiment of the system according to the invention.

FIG. 1b is a cross section of a variant of the embodiment shown in FIG. 1a.

FIG. 2 is a cross section of the embodiment shown in FIG. 1a wherein a throttle valve is present at the second filtrate as pressurising means.

FIG. 3 is a cross section of the embodiment shown in FIG. 2 wherein a valve is present at the waste outlet.

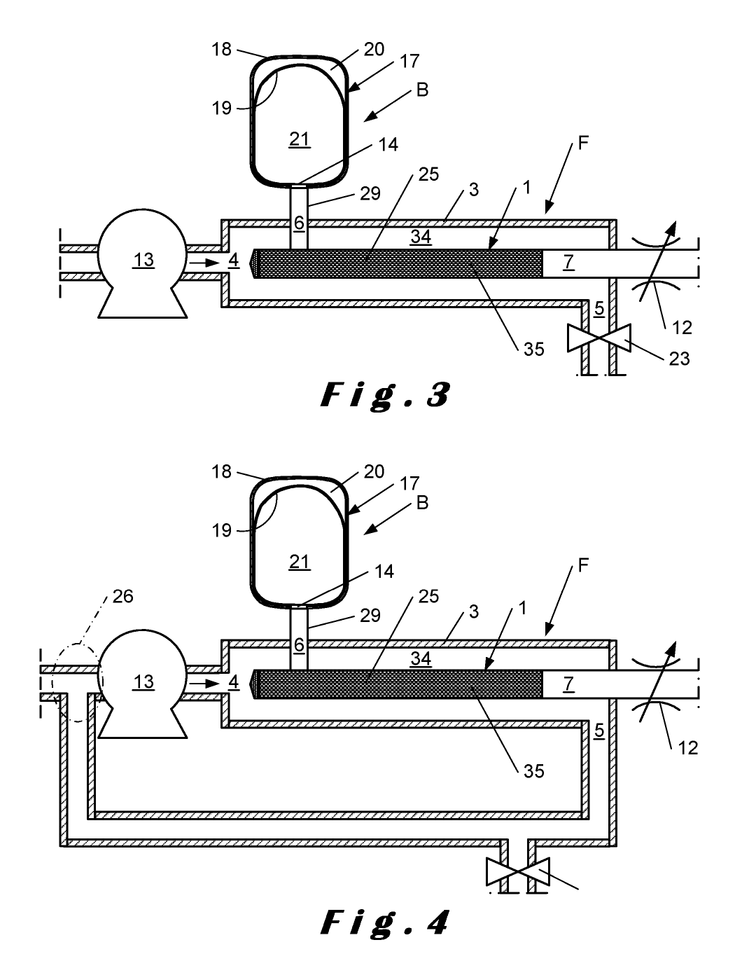

FIG. 4 is a cross section of the embodiment shown in FIG. 2 wherein the concentrate outlet is connected to the raw material inlet and wherein a drawdown valve is present.

FIG. 5 is a cross section of a variant of the embodiment shown in FIG. 1a.

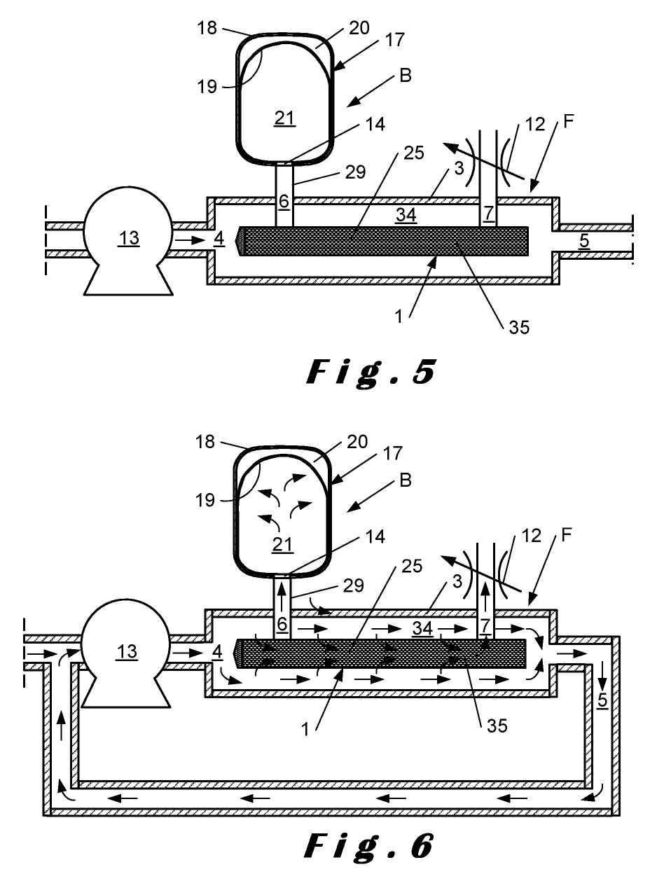

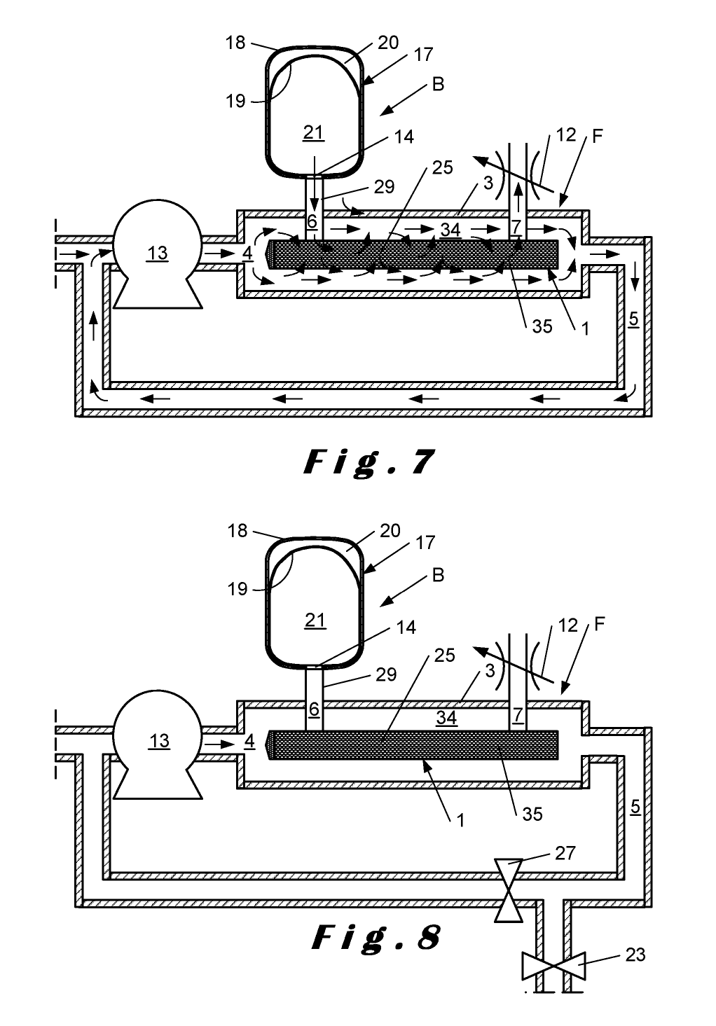

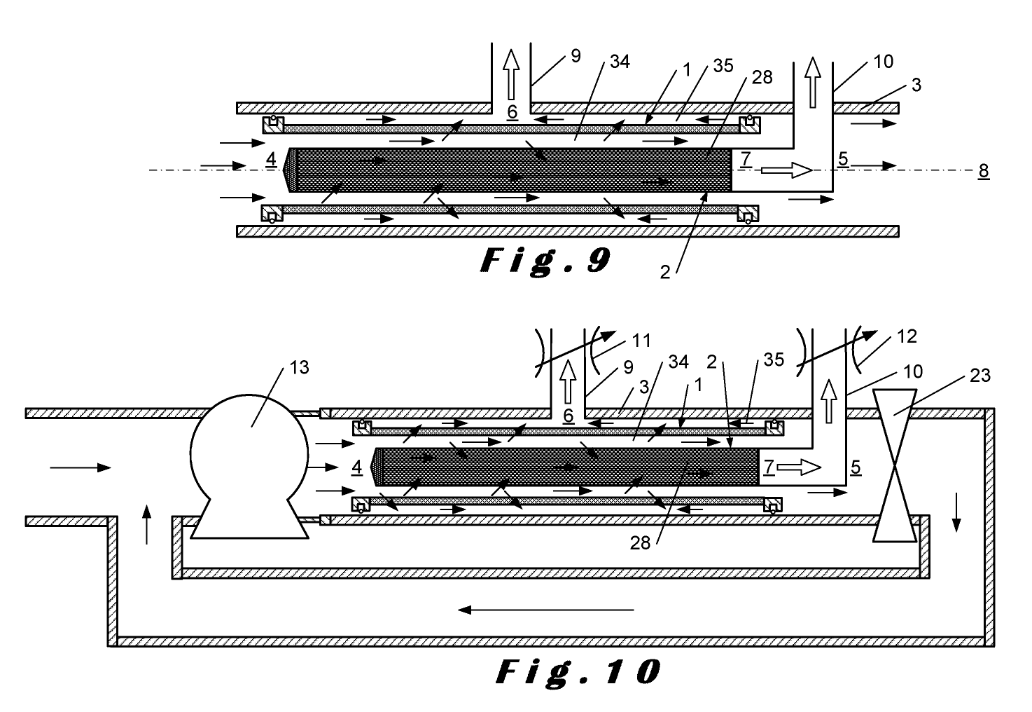

FIG. 6 is a cross section of the embodiment shown in FIG. 5 wherein the concentrate outlet is connected to the raw material inlet in filtration operation.

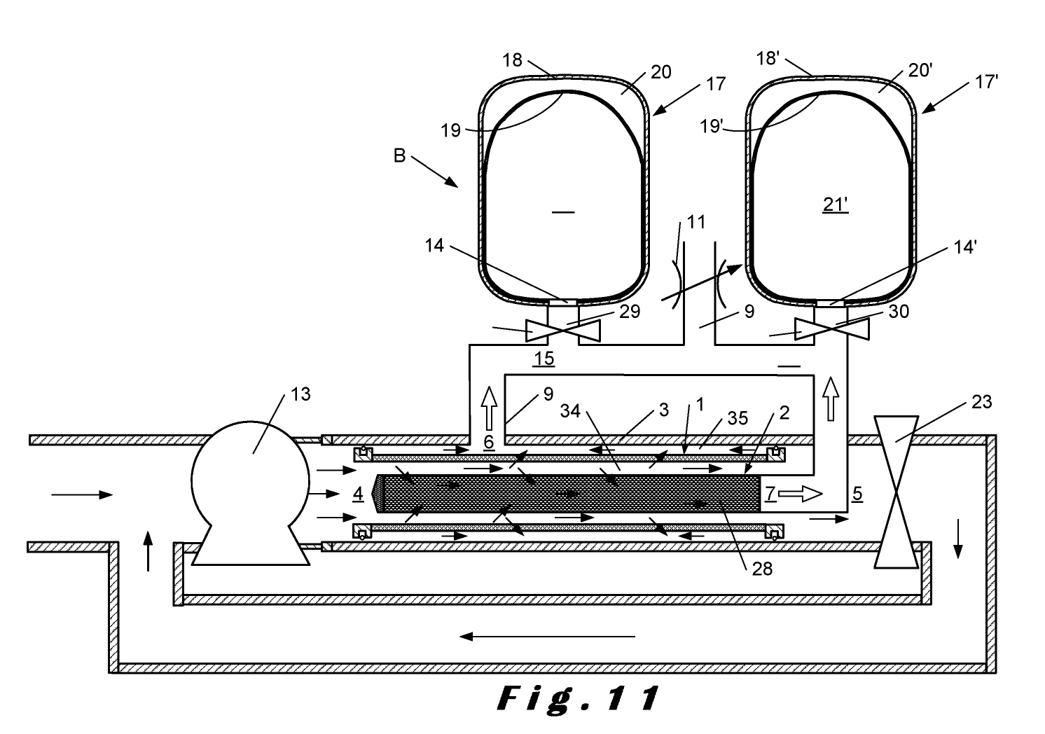

FIG. 7 is a cross section of the embodiment shown in FIG. 5 wherein the concentrate outlet is connected to the raw material inlet in back-flush operation.

FIG. 8 is a cross section of the embodiment shown in FIG. 5 wherein the concentrate outlet is connected to the raw material inlet and wherein a drawdown valve is present for using the system either with a dead end filter unit or with a cross flow filter unit.

FIG. 9 is a cross section of a particular filter unit to be used in the system according to the invention.

FIG. 10 is a cross section of the particular filter unit of FIG. 9 wherein the concentrate outlet is connected to a pump being itself connected to the raw material inlet.

FIG. 11 is a cross section of a particularly preferred embodiment having two concentric filter elements, two expansion vessels and a single filtrate harvesting nozzle.

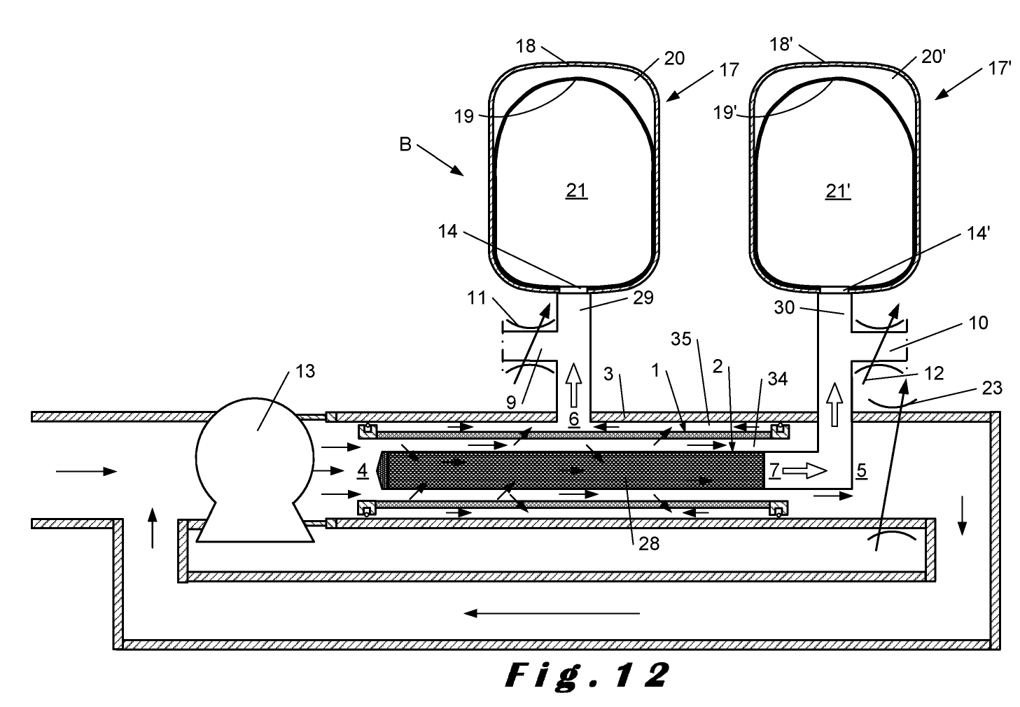

FIG. 12 is a cross section of a variant embodiment according to the invention having two concentric filter elements, two expansion vessels, each expansion vessel being connected to its own filtrate outlet and to a filtrate harvesting nozzle.

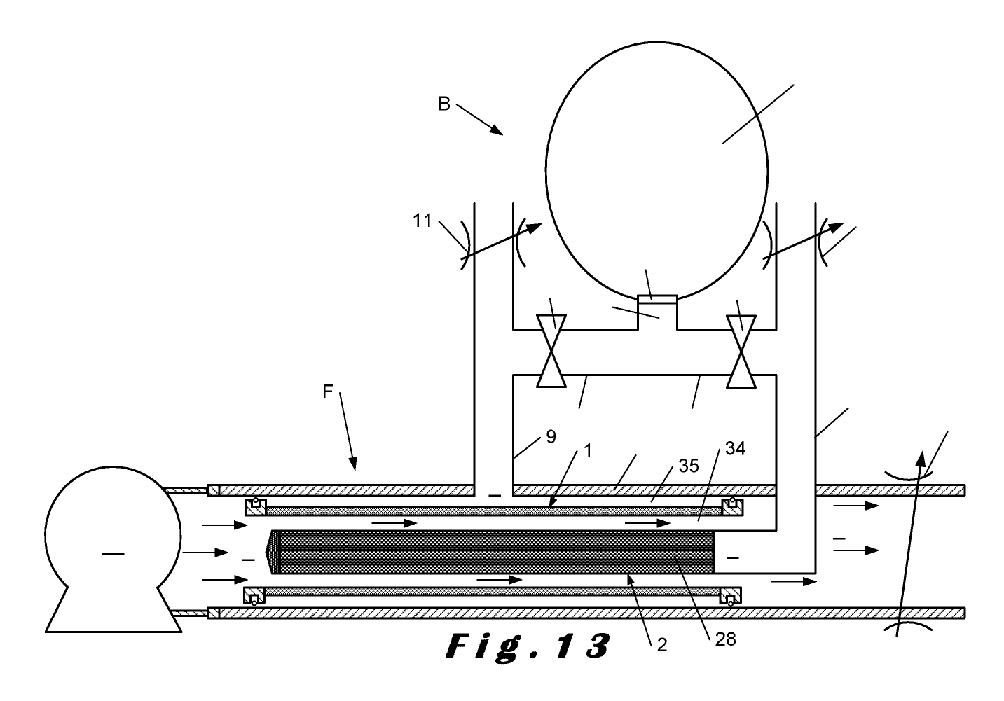

FIG. 13 is a cross section of another embodiment according to the invention having two concentric filter elements, a single expansion vessel connected to both filtrate outlets, each filtrate outlet being connected to a separate filtrate harvesting nozzle.

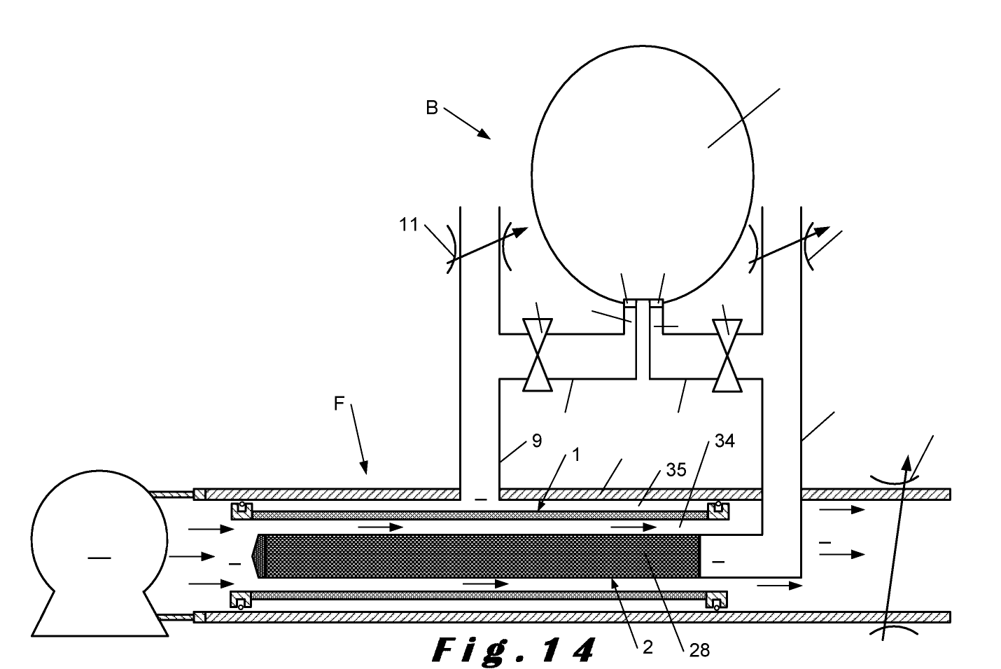

FIG. 14 is a cross section of a variant embodiment of FIG. 13 wherein two back-flush nozzles are present for a single expansion vessel.

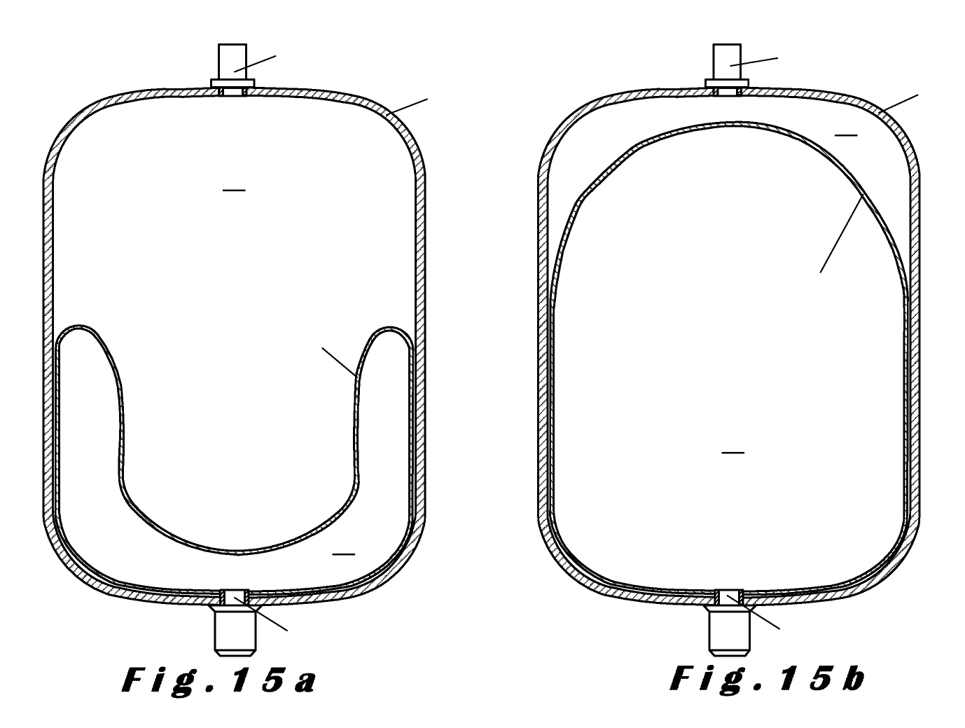

FIG. 15a is a cross section of the expansion vessel of the back-flush unit without filtrate and 15b is the same representation of the expansion vessel but full of filtrate.

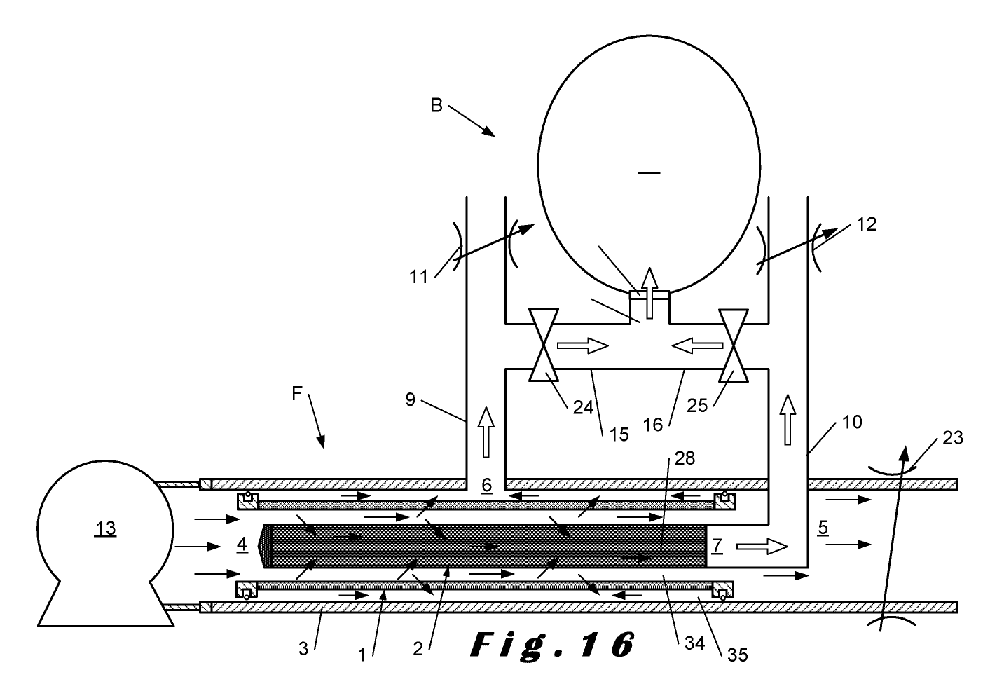

FIG. 16 is a cross section of the filter system shown in FIG. 13 showing the filling and the pressurising of the expansion vessel with filtrate.

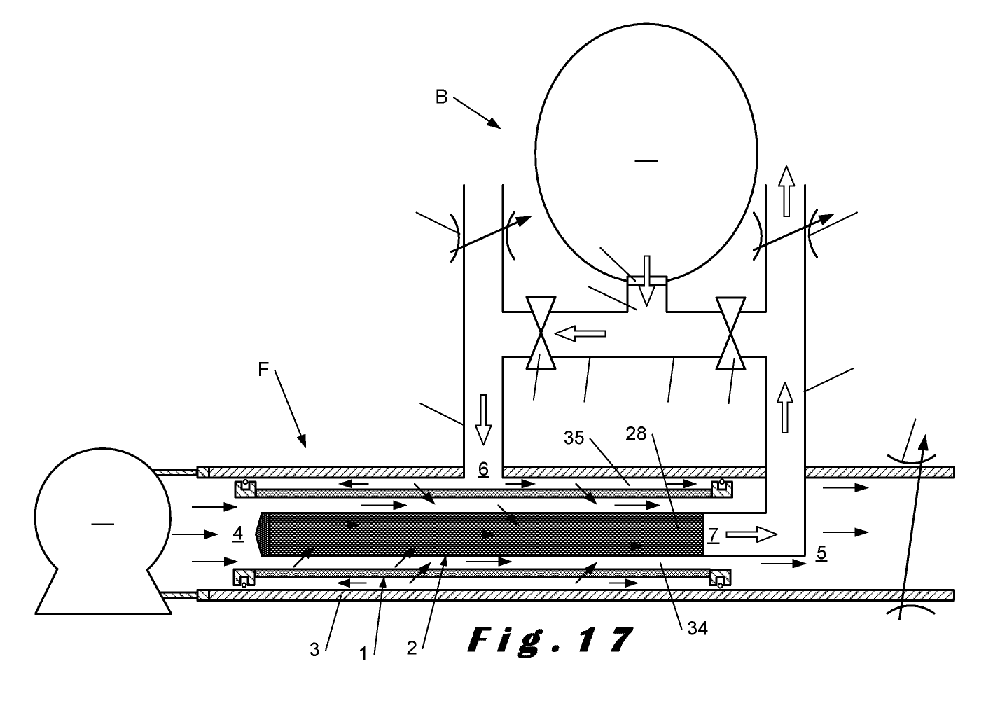

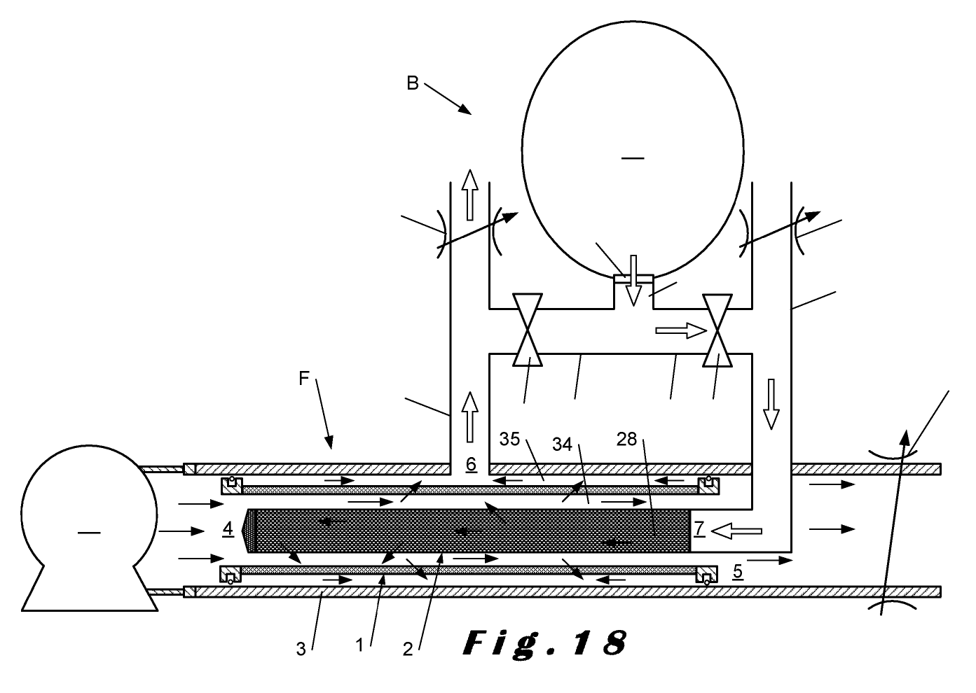

FIG. 17 is a cross section of the filter system shown in FIG. 13 showing the back-flushing of the first filter element to remove deposition of particles while the second filter element is still in operation.

FIG. 18 is a cross section of the filter system shown in FIG. 13 showing the back-flushing of the second filter element to remove deposition of particles while the first filter element is still in operation.

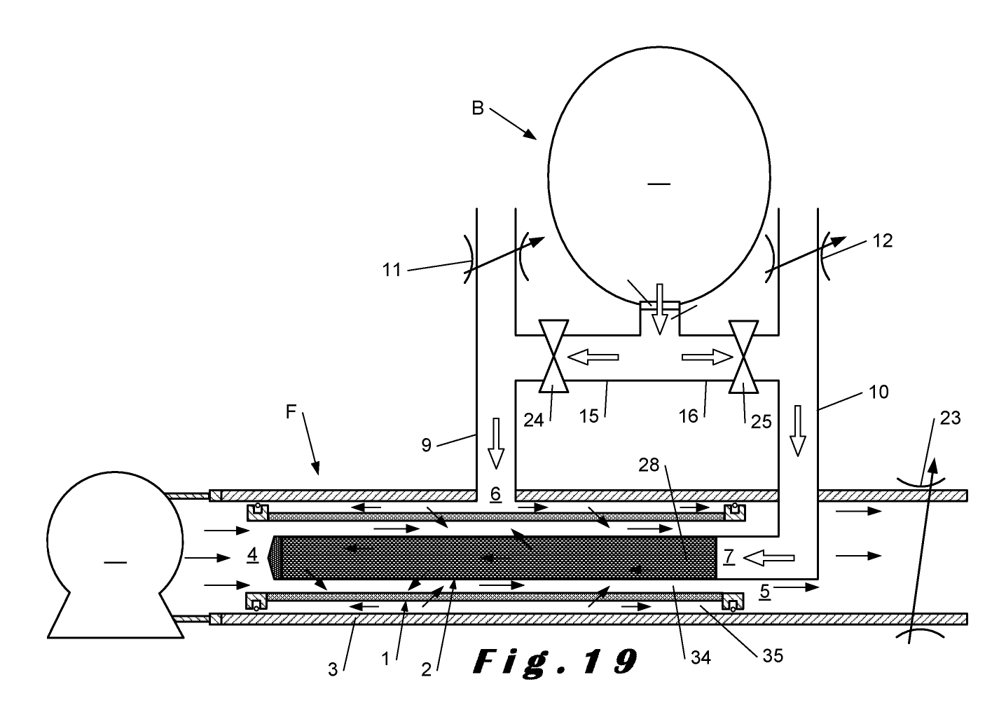

FIG. 19 is a cross section of the filter system shown in FIG. 13 showing the back-flushing of the first and of the second filter elements to remove deposition of particles. Circulation of raw material is continued to take the removed deposition into concentrate flow.

In the drawings, a same reference sign has been allotted to a same or analogous element of the filter system according to the invention.

As mentioned before, FIG. 1a shows a cross section of an embodiment of the system according to the invention and FIG. 1b shows a cross section of a variant of the embodiment shown in FIG. 1a.

The filter system according to the invention comprises a filter unit F comprising a first filter element 1, preferably a longitudinal filter element 1 and a housing 3. The first filter element 1 is located inside the housing 3. The filter unit also comprise a raw material inlet 4 and an outlet 5 for a concentrate or for a waste product.

Moreover, the filter system comprises pressurising means comprising a pump 13.

The filter unit of the filter system shown in FIG. 1a is either a dead end filter or a cross flow filter. If the filter unit is a dead end filter, the outlet 5 is a waste outlet 5 and if the filter unit is a cross flow filter unit, the outlet 5 is a concentrate outlet 5. In this latter case, the concentrate outlet 5 will be connected to the pump 13.

The filter element 1 separates a raw material compartment 34 from a filtrate compartment 35. Both compartments 34,35 being inside the housing 3. The raw material inlet 4 is in communication with said raw material compartment 34 and the filtrate compartment 35 is in communication with a first filtrate outlet 6 and with a second filtrate outlet 7. The first filtrate outlet is also connected to the back-flush unit B, in particular to the expansion vessel 17.

the expansion vessel 17 of the back-flush unit B comprises a housing 18 and a diaphragm 19 provided to divide said expansion vessel 17 into a first compartment 20 and a second compartment 21. The expansion vessel further comprises a filtrate port 14 which is connected to the first filtrate outlet 6 by means of a first back-flush nozzle 29.

The filter unit F of the filter system according to the invention is provided to filter a raw material comprising particles in suspension or in solution in a fluid. The first filter element 1 has a predetermined pore size and is provided to filter the raw material. Therefore, when the filter element 1 is in filtration operation, particles having a size greater than the predetermined pore size are retained in the raw material compartment 34 and the particles having a size smaller than the predetermined pore size pass through the filter element 1. Therefore, after filtration, or ultrafiltration, depending on the cut-off of the filter element 1, a filtrate being the raw material substantially depleted in particles and a raw material enriched in particles are both obtained. The filtrate exits the filter unit F either by the first 6 or the second filtrate outlet 7. The raw material substantially enriched in particles exits the filter unit through the outlet 5.

The first compartment 20 of the expansion vessel 17 is provided to contain a compressible medium, for example air, or another gas and the second compartment 21 is provided to contain the filtrate.

When the system is in filtration operation, the pump 13 forces the raw material to enter the filter unit F through the raw material inlet 4. The particles having a size smaller than the predetermined pore size of the filter element 1 pass through this element 1 and reach the filtrate compartment 35 whilst the particles having a size greater than the predetermined pore size are retained in the raw material compartment 34.

The filtrate can reach either the second compartment 21 of the expansion vessel 17 of the back-flush unit B or the second filtrate outlet 7 of the filter unit F.

When the surface of the filter element 1 is clogged by particles, the filter unit F should be back-flushed by the back-flush unit B to remove the deposition of particles.

The clogging of the filter unit F can be automatically monitored by measuring the pressure or the flow rate in the filter unit F. Hence means can be provided (not illustrated in the figures) to initiate automatically the back-flush operation when the measured values of pressure or flow rate indicate that such an operation is needed, or when a pressure or flow rate threshold has been reached.

In the embodiment illustrated in FIG. 1a, the filtrate compartment 35 is the internal compartment of the filter element 1.

The pump 13 acting as pressurising means is also provided to pressurise the filtrate when it is in the second compartment 21 of the expansion vessel 17. Therefore, when the pump 13 causes an increase of the flow rate of the raw material, this will result in an increase of the filtrate flow rate in the filtrate compartment 35 since the outlet flow rate at the second filtrate 7 will be the same. This will cause the filling of the second compartment 21 of the expansion vessel 17. When returning to the initial flow rate of the raw material inlet 4, or when substantially reducing the flow rate of the raw material inlet 4, this will cause an abrupt reduction of pressure in the raw material compartment and in the filtrate compartment 35. This abrupt reduction of pressure will be equilibrated by the filtrate contained in the second compartment 21 of the expansion vessel 17 which will return in the filtrate compartment and then pass through the filter element to reach the raw material compartment and counterbalance the reduction of pressure. Hence, the filter unit F will be back-flushed without being stopped as the raw material flow rate never reach the zero value. Indeed, filtrate comes out of the second compartment 21 of the expansion vessel 17 into the filtrate compartment 35, pass through the filter element. This causes the expulsion of the particles clogged at the external surface of the filter element 1 by creating a high pressure rapid burst of filtrate. Thus, the particles will be removed by the raw material flow through the outlet 5 while the filtration operation continues in the filter unit. Therefore, the system according to the invention is particularly advantageous by providing a continuous filtration operation even when the filter unit is in back-flush operation.

As can be seen in FIG. 1 and in all following figures, the fact that the first filtrate outlet 6 is provided at one end of the filter unit and upstream the second filtrate outlet 7, being at the other end of the filter unit in view of a filtrate direction when the filter unit is in filtration operation allows the continuous filtration operation and increase the back-flush effect by having two flow rate in the same direction.

Of course, both filtrate outlets can be more close one to each other while being in the aforementioned order (first filtrate outlet upstream the second filtrate outlet), but it is preferred that the filtrate outlets are each placed at a nearly terminal end of the filter unit for limiting the dead zones inside the filter unit.

Therefore, the back-flush operation does not present an opposite flow rate in view of the filtrate direction during the filtration operation and therefore, both operations can be done simultaneously.

Indeed, during the back-flush, the filtration operation and the back-flush operation have both the same direction of flow rate and not two opposite flow rates exerting a force on each other and therefore, the flushing effect of the filter unit of the system according to the invention is increased.

FIG. 1b shows an alternative embodiment. In this embodiment, the filtrate compartment 35 is the compartment around the filter element 1 and the raw material compartment 34 is the internal compartment of the filter element 1. The operation of the filter system either in filtration operation or in back-flush operation is the same as previously mentioned.

FIG. 2 shows a preferred embodiment according to the invention being the embodiment shown in FIG. 1a with a throttle valve 12 at the second filtrate outlet 7.

In this embodiment, the pump 13 and/or the throttle valve 12 can act as pressurising means for varying the flow rate in the filter unit F and for providing a continuous filtration operation.

Indeed, the pump 13 can maintain a constant flow rate at the raw material inlet 4 and the throttle valve 12 can act as means for increasing the pressure. The throttle valve 12 can thus reduce the flow rate at the second filtrate outlet 7. For example, if the flow rate at the second filtrate outlet 7 is decreased, the pressure in the filtrate compartment 35 increases, causing the filling of the second compartment 21 of the expansion vessel 17. When a back-flush operation is needed, the pump 13 can decrease the flow rate of the raw material and the pressure in the raw material compartment is decreased. Hence, the filtrate contained in the filtrate compartment and in the expansion vessel will counterbalance this reduction of pressure. Therefore, the filter unit will be back-flushed without being stopped as the filtrate flow rate at the filtrate outlet 7 never reaches the zero value.

FIG. 3 shows a particular embodiment of the system illustrated in FIG. 2 wherein the filter unit can be used as a dead end filter unit or as a cross flow filter unit respectively having a waste outlet 5 or a concentrate outlet 5 provided with a valve 23.

In some cases, when a dead end filter unit is needed, the valve 23 at the waste outlet 5 is closed. The waste material is thus maintained in the raw material compartment and when the waste material should be removed, the valve 23 will be opened by the user to collect it, for example in a waste tank.

The filtration operation and the back-flush operation are the same as mentioned before for FIG. 2 except for the raw material which is maintained in the filter unit.

When a cross flow filter is needed, the valve 23 at the concentrate outlet is open and the concentrate is continuously harvested. In this embodiment, the filtration operation and the back-flush operation are the same as mentioned before for FIG. 2 (except that it is the concentrate which removes the particles clogged when the filter unit F is back-flushed and that the valve 23 can act as pressurising means). Indeed, when the filter unit has to be back-flushed, the drawdown in the raw material compartment can be created either by the valve 23 at the concentrate outlet or by the pump 13 at the raw material inlet 4.

In one case, the pump 13 will reduce the flow rate to create this drawdown in the raw compartment, in the other case, the throttle valve 23 will increase the flow rate of the outlet to create this drawdown in the raw material compartment. Therefore, as the filtrate outlet is partially obstructed, the filtrate contained in the expansion vessel and in the filtrate compartment will equilibrate the drawdown of pressure in the raw material compartment by passing through the filter element and thus by back-flushing the filter element.

As illustrated in FIG. 4, the concentrate outlet 5 can also be connected to the raw material inlet 4 by a three way connecting means 26 for increasing the concentration effect of the filter element.

The three-way-connecting means 26 comprise a first end, a second end and a third end. The first end is connected to the filter unit F. The pump 13 can comprise the three-way-connecting means 26 or can be connected to the first end of the three-way-connecting means 26. The second end is provided to be connected to the source of raw material and the third end can be provided to be connected to the concentrate outlet.

As illustrated in FIG. 4, a concentrate draw off outlet is provided with a valve 23. This outlet allows to collect the concentrate when it is for example too viscous or enough concentrated. For example, when the concentrate has removed a lot of clogged particles during the back-flush operation, it can be advantageous to exit this concentrate with a high level of particles for not reintroducing it in the filter circuit.

FIG. 5 shows another arrangement of the second filtrate outlet 7 with its throttle valve 12.

FIG. 6 and FIG. 7 show the filter system according to the invention respectively in filtration operation while filling the expansion vessel (FIG. 6) and in back-flush operation while filtration is continued.

As it can be seen in FIG. 6, a raw material is pumped by the pump 13, for example from a raw material tank. The raw material enters the filter unit F through the raw material inlet 4. The particles having a size smaller than the predetermined pore size of the filter element 1 pass through this element 1, reach the filtrate compartment 35 and become the filtrate whilst the particles having a size greater than the predetermined pore size are retained in the raw material compartment 34.

The filtrate is provided to exit the filter unit through the first filtrate outlet 6 or through the second filtrate outlet 7. When exiting the filter unit F through the second filtrate outlet 7, the filtrate is harvested and the throttle valve 12 is open. When the expansion vessel 17 has to be filled by the filtrate, the valve 12 is partially closed to reduce the flow rate through the second filtrate outlet 7 and the pressure in the filtrate compartment 35 increases. The filtrate contained in the filtrate compartment 35 can thus fill the second compartment 21 of the expansion vessel 17 and further compresses the air contained in the first compartment 20 (see also FIG. 15a and 15b).

The raw material substantially enriched in particles circulates in the raw material compartment 34, and is therefore called concentrate since this configuration is a cross flow filter unit. The concentrate exits the filter unit F and returns to the pump by a nozzle connected to the third end of the three way connecting means 26. Therefore the pump forces both a new raw material to enter the filter unit F and the concentrate to increase the concentration effect.

When the filter element 1 is clogged with particles, the filter unit has to be back-flushed. Therefore, the pressure in the filtrate compartment has to be decreased, for example by the pump 13 acting as “de-pressurising means”.

When the pressure in the raw compartment 34 and then in the filtrate compartment 35 is decreased, the filtrate contained in the second compartment 21 of the expansion vessel 17, pushed by the compressed gas contained in the first compartment 20, will equilibrate the abrupt pressure drop in the raw material compartment 34, by flowing from the filtrate side to the raw material side through the filter element. The filter unit F will be back-flushed without being stopped as the filtrate flow rate at the filtrate outlet 7 never reaches the zero value. The particles clogged at the surface of the filter element 1 will be expulsed by the filtrate from the expansion vessel 17 through the wall of the filter element 1. The clogged particles will be removed by the concentrate being in the raw material compartment 34 and will exit the filter unit through the concentrate outlet. Of course, the pressure in the filtrate compartment during the filling of the second compartment 21 of the expansion vessel 17 can also be increased by the pump 13 by increasing the flow rate of the raw material and by forcing the filtration of this latter. This will create an overpressure in the filtrate compartment which will contribute to the filling of the expansion vessel 17.

FIG. 8 illustrates a particularly advantageous embodiment which is very flexible. Indeed, the nozzle between the waste outlet 5 or concentrate outlet 5 and the raw material inlet comprises a waste drawdown outlet or a concentrate drawdown outlet comprising a valve 23. If this valve is open, the filter unit is a dead end filter unit and the outlet with the valve 23 is a waste outlet.

If the valve 23 is closed, the filter is a cross flow device having a concentrate outlet for harvesting the concentrate when needed. Moreover, the valve 23 is particularly a throttle valve for acting as pressurising means as mentioned before. Other additional valves can be present such as valve 27 in the connection between the raw material inlet 4 and the outlet 5. Therefore either the valve 23 or 27 can be throttled to increase the pressure in the raw material compartment or to decrease the pressure in this lafter.

FIG. 9 shows a particularly preferred filter unit for using in the filter system according to the invention.

The filter unit comprises a longitudinal first filter element 1 and a longitudinal second filter element 2 installed substantially concentrically, inside the first filter element 1.The cross flow filter unit also comprises a housing 3 surrounding the first filter element 1, a raw material inlet 4, a concentrate outlet 5, and a first filtrate outlet 6 connected to the first filter element 1. As it is shown here, the raw material inlet 4 and the concentrate outlet 5 are preferably substantially aligned, in particular, aligned with said longitudinal central axis 8. In this preferred embodiment, the second filter element 2 is connected to its own filtrate outlet called the second filtrate outlet 7.

As illustrated in FIG. 10, the first 6 and the second filtrate outlets 7 are respectively extended by a first filtrate harvesting nozzle 9 and a second filtrate harvesting nozzle 10. The first filtrate harvesting nozzle 9 is ended by a first throttle valve 11 and the second filtrate harvesting nozzle 10 is ended by a second throttle valve 12.

Moreover, in a preferred embodiment, a circulation pump 13 is provided between the concentrate outlet 5 and the raw material inlet 4.

The raw material to be filtered can be pumped from a process plant or from a raw material tank to the cross flow filter unit.

The raw material inlet is supplied tangentially to the filter media surface of the filter element as indicated by arrows.

The second filtrate outlet 7 is connected to a second filtrate harvesting nozzle 10 and the second filtrate harvesting nozzle 10 comprises a second throttle valve 12. The first filtrate outlet 6 is also connected to a first filtrate harvesting nozzle 9 and comprises a first throttle valve 11. Both valves 11,12 are preferably separately controlled allowing to operate the two filter elements 1,2 independently. The first filter element 1 can be in a cleaning cycle when the second 2 is in filtration operation.

When in service, the raw material is fed by the circulation pump 13 through the raw material inlet 4 into the raw material compartment 34 being between the two filter elements 1,2. Depending on the cut-off of the filter elements 1,2, the fluid (liquid or gas) passes through the filter elements 1,2, which fluid contains several particles which are smaller than the size of the filter element pores and respectively reaches the filter filtrate compartment 35 or the second filtrate compartment 28. Greater particles remain into the raw material compartment 34 between both filter elements 1,2. A portion of the particles will be deposited upon the surface of the filter elements and the other portion will be carried away by the flow. This is the reason why the outlet of raw material is called concentrate outlet 5 as the fluid is enriched with particles.

In FIG. 11, the filter system comprises two expansion vessels 17, 17′ and a single filtrate harvesting nozzle 9, in communication with both filtrate outlets 6, 7.

The first filtrate outlet 6 is connected to the second compartment 21 of the first expansion vessel 17 by means of a first communication nozzle 15. The first communication nozzle 15 connects a first back-flush nozzle 29 communicating with the port 14 of the second compartment 21 of the first expansion vessel 17 to the first filtrate outlet 6.

The second filtrate outlet 7 is connected to the second compartment 21′ of the second expansion vessel 17′ by means of a second communication nozzle 16. The second communication nozzle 16 connects a second back-flush nozzle 30 communicating with the port 14′ of the second compartment 21′ of the second expansion vessel 17′ to the second filtrate outlet 7.

Both communication nozzles 15 and 16 are in communication with the first filtrate harvesting nozzle 9 provided with its throttle valve 11.

Both back-flush nozzles 29 and 30 are also provided with a first valve 24 and a second valve 25.

In this preferred embodiment, two filter elements 1,2 are provided, having both their own filtrate outlet 6, respectively 7. Each filtrate outlet 6,7 is connected to its own expansion vessel 17, respectively 17′ by means of a first 15 and a second communication nozzle 16 and by means of back-flush nozzles 29 and 30, both comprising a valve 24, respectively 25. Both filtrate outlets 6,7 are also connected to a single filtrate harvesting nozzle 9 provided with a throttle valve 11.

When starting the system and when starting the filtration operation, both valves 24,25 of the back-flush nozzles 29, 30 are in open position to allow the filtrate for filling the second compartments 21,21′ of both expansion vessel 17,17′. When the level of filtrate in the expansion vessels 17,17′ is sufficient, the valves 24,25 in open position have to be closed. Then the filtration operation normally continues and the filtrate is harvested at the first filtrate harvesting nozzle 9.

When the filter unit F is clogged or showing deposits, the valve 24 of the first back-flush nozzle 29 or the valve 25 of the second back-flush nozzle 30 will be opened to clean the surface of the first 1 or of the second filter element 2 while respectively the valve 25 of the second back-flush nozzle 30 or the valve 24 of the first back-flush nozzle 29 is in closed position allowing the filter unit to continuously operate.

Because the expansion vessel is connected by means of two back-flush nozzles 29, 30 and by means of two communication nozzles 15,16 to the two filtrate outlets 6,7 and therefore to the two filtrate compartments 28, 35 of the filter unit F, when a filter 1 or 2 has to be cleaned, it can be in a cleaning cycle while the other remaining in use (2 or 1).

Therefore, the filter system is a continuous system allowing a continuous filtration process to be carried out in the filter unit F when a cleaning step is needed. Indeed, when acting on the pressurising means being even the pump 13 or the throttle valve 11, it is possible to increase the flow rates or the pressures in the compartments of the filter and thus to fill the expansion vessel with filtrate.

FIG. 12 is a cross section of another embodiment according to the invention wherein two expansion vessels are present, each expansion vessel being connected to its own filtrate outlet and to a filtrate harvesting nozzle.

In this embodiment, the first filtrate outlet 6 is connected to the first harvesting nozzle 9 and to the first back-flush nozzle 29. The first back-flush nozzle 29 is provided to feed the second compartment 21 of the first expansion vessel 17 through the port 14 with filtrate. The first harvesting nozzle 9 comprises the first throttle valve 11.

The second filtrate outlet 7 is connected to a second harvesting nozzle 10 and to the second back-flush nozzle 30. The second back-flush nozzle 30 is provided to feed the second compartment 21′ of the second expansion vessel 17′ through the port 14′ with filtrate from the second filtrate compartment. The second harvesting nozzle 10 comprises the second throttle valve 12.

The operation is the same and provides the same advantages of the filter system of FIG. 10.

In the embodiment illustrated in FIG. 13, the first filtrate outlet 6 is connected to a first filtrate harvesting nozzle 9 comprising a throttle valve 11. The first filtrate harvesting nozzle 9 is connected to the first communication nozzle 15 thereby connecting the first back-flush nozzle 29 to the first filtrate outlet 6. The first back-flush nozzle 29 feeds the filtrate to the second compartment 21 of the expansion vessel 17 through a first port 14.

The second filtrate outlet 7 is connected to a second filtrate harvesting nozzle 10 comprising a throttle valve 12. The second filtrate harvesting nozzle 10 is connected to the second communication nozzle 16 thereby connecting the first back-flush nozzle 29 to the second filtrate outlet 7. The first back-flush nozzle 29 feeds the filtrate to the second compartment 21 of the expansion vessel 17 through a first port 14.

This system functions as mentioned before, also providing the same advantages than the system shown in FIGS. 11 and 12. However, the presence of a single expansion vessel substantially reduces the cost of the system according to the invention.

In a variant illustrated in FIG. 14, the second filtrate outlet 7 is connected to the second filtrate harvesting nozzle 10 comprising the throttle valve 12. The second filtrate harvesting nozzle 10 is connected to the second communication nozzle 16 thereby connecting a second back-flush nozzle 30 to the second filtrate outlet 7. The second back-flush nozzle 30 feeds the filtrate to the second compartment 21 of the expansion vessel 17 through a second port 14′.

FIG. 15 shows details of the expansion vessel of the back-flush device according to the invention.

FIG. 15a shows the expansion vessel 17 without filtrate and 15b is the same representation of the expansion vessel 17 but full of filtrate. The expansion vessel 17 is, in particular, an expansion vessel 17 similar to those used in heating systems.

The expansion vessel 17 comprises a housing 18, preferably made of stainless steel, a diaphragm 19 dividing the vessel in two parts, an external first part 20 provided to contain a gas (being in fact contain out of the diaphragm 19 and within the housing 18) and a internal second part 21 provided to contain a liquid (being the interior of the diaphragm 19). The diaphragm 19 is preferably interchangeable and made of butyl rubber. The material used to manufacture the expansion vessel housing 18 can be any material but preference is given to stainless steel because all component that are not made of this material can be damaged by salt or other substances that may optionally be contained in filtrate or in air.

Also the diaphragm 19 can be made of any material well known by those skilled in the art, but butyl rubber is preferred for its elasticity, resistance and neutrality. It should be understood that preferably, the material either for the expansion vessel housing 18 or the diaphragm 19 are chosen to not interact with liquid or gas that will be contained into the expansion vessel 17.

In this particular embodiment, the expansion vessel further comprises a single port 14 as inlet and outlet for filtrate since valves can be present to impose the sense of the filtrate (coming in or out). It should be intended that two ports can also be present i.e. an inlet port and an outlet port or two ports being each inlet and outlet without changing anything to the operation of the back-flush device.

The port 14 is provided to allow the filtrate coming from the filter unit to fill through the diaphragm 19 the second compartment 21 of the expansion vessel 17 which is provided to contain the filtrate.

An additional valve 22 is provided in the first compartment 20 to allow excess of gas to go out to avoid the overpressure in the first compartment 20 of the vessel 17.

FIG. 16 shows the embodiment of the filter system according to the invention wherein a single expansion vessel 17 having a first port 14 (inlet), which is also the second port (outlet), is present. A first communication nozzle 15 is connected to the first port 14 of the expansion vessel 17 by the first back-flush nozzle 29 and to said first filtrate harvesting nozzle 9 between the first filtrate outlet 6 and the first throttle valve 11, and a second communication nozzle 16 is connected to the port 14 of the expansion vessel 17 and to the second filtrate harvesting nozzle 10 between the second filtrate outlet 7 and the second throttle valve 12.

The first communication nozzle 15 comprises a first valve 24 between the first filtrate harvesting nozzle 9 and the port 14 of the expansion vessel. The second communication nozzle 16 comprises a second valve 25 between the second filtrate harvesting nozzle 10 and the port 14.

The first throttle valve 11 and the second throttle valve 12 of the filtrate outlets 6, 7 can be directly connected by nozzles to another process plant for immediate use or to one or two filtrate tanks for storage.

As aforementioned, the raw material to be filtered is fed by a circulation pump 13 from a process plant or from a raw material tank to the filtration device.

It should be intended that it can be the circulation pump 13 or another pump which supplies the raw material to be filtered to the filtration device. Indeed, the circulation pump 13 can make the connection between the raw material tank and the concentrate outlet 5 before supplying a mixture of the raw material and of the concentrate at the inlet 4 of the filtration device.

Moreover, the concentrate outlet 5 is ended by a valve 23, being in particular a throttle valve. The throttle valve is provided to regulate the flow rate of the concentrate by throttling this latter.

As can be seen in FIG. 13, and as mentioned before, when in service, the raw material is fed by the circulation pump 13 through the raw material inlet 4 into the raw material compartment 34 between the two filter elements 1,2. The fluid (liquid or gas) passes through the filter media of the filter elements 1,2 containing several particles which are smaller than the size of the filter media pores and reaches the first 35 and the second filtrate compartment 28. Greater particles remain into the raw material compartment 34 between both filter elements 1,2. A portion of the particles will be deposited upon the surface of the filter media and the other portion will be carried out by the flow.

The fluid which has passed through the filter elements 1,2 exits via the first 6 and the second filtrate outlet 7 and is either directed to another process plant, to a filtrate tank or to the back-flush device, depending on the valve positions. The operation of the filter unit using the back-flush device is explained hereinafter in more details.

As can be seen in FIG. 15b, the filtrate is fed in the first part 21 which increase in volume with filling. The filling with filtrate of this area results in a pressurisation of the second part 20 as the gas contained in the second part 20 is compressed by the increasing volume of the first part 21.

Therefore, the second part 20 exerts also a pressure onto the diaphragm 19, which pressure is useful to clean one or both filter elements 1,2 when back-flush flow is required.

FIG. 16 shows several possibilities for the filling and the pressurising of the expansion vessel with filtrate. The direction of the filtrate flows is indicated by arrows in the different nozzles.

To build up pressure, the first 24 and the second 25 valves should be in open position and the first throttle valve 11 and the second throttle valve 12 should be in a nearly closed position or in a closed position. Therefore, the expansion vessel 17 is pressurised using the filtrate flow. In a similar way, by throttling the throttle valve 23 of the concentrate outlet 4, the pressure of the filtrate flow is increased so that the pressure builds up in the filtration device. This effect can also be reached by acting on the flow rate of the pump 13, all combinations of acting on pressuring means (first throttle valve 11, second throttle valve 12, valve 23 of the concentrate outlet, pump 13) being possible.

This pressure will go through the filter elements 1, 2 to the filtrate side of the filtration device and thus, this pressure can be used to pressurise the expansion vessel 17 by filing it with the filtrate.

It should be understood that the expansion vessel 17 can be filled only with the filtrate coming from the first filter element 1, from the second filter element 2 or both.

Throttles valves (11,12) have been considered at the filtrate outlets of the filtrate harvesting nozzles but they can also be common open/closed valve as the pressurisation-depressurisation of the filtrate can be done by the pump 13 or the throttle valve 23.

The following table (Table 1) shows different possible configurations of the valves to fill the expansion vessel with filtrate while the arrows in FIG. 16 show the direction of the filtrate flows during these operations.

TABLE 1

| | first | Second | First | Second |
|---|---|---|---|---|
| | throttle | throttle | valve | valve |
| | valve (11) | valve (12) | (24) | (25) |
| Fill via second filter element | open | closed or | closed | open |
| (2) | | nearly | | |
| | | closed | | |
| Fill via first filter element | closed or | open | open | closed |
| (1) | nearly | | | |
| | closed | | | |
| Fill via both filter element | closed or | closed or | open | open |
| (1 and 2) | nearly | nearly | | |
| | closed | closed | | |

For example when the throttle valve 23 of the concentrate outlet has been nearly closed and once the expansion vessel 17 has reached its maximal pressure, the first 24 and/or the second valves 25 are closed and the valve 23 is re-opened by throttling to allow the concentrate outlet so that the cross flow effect comes back in the module.

FIG. 17 shows the back-flushing of the first filter element 1 to remove deposition of particles while the second filter element 2 is still in operation.

For the following explanation, it should be envisaged that the expansion vessel 17 has reached its maximal pressure, and that the filtration device has been operated between the filling of the expansion vessel and the cleaning of the first filter element 1.

The following table (Table 2) shows the position of the valves when the first filter element 1 is back-flushed while the second filter element 2 is in operation. The direction of the filtrate during this operation is indicated by arrows in FIG. 17.

TABLE 2

| | First | Second | First | Second |
|---|---|---|---|---|
| | throttle | throttle | valve | valve |
| | valve (11) | valve (12) | (24) | (25) |
| Back-Flush of the first filter | closed or | open | open | close |
| element 1, second filter element | nearly | | | |
| 2 in operation | closed | | | |

FIG. 18 shows the back-flushing of the second filter element 2 to remove deposition of particles while the first filter element 1 is still in operation.

The following table (Table 3) shows the position of the valves during the back-flushing of the second filter element 2 while the operation of the first filter element 1. The direction of the filtrate during this operation is indicated by arrows in FIG. 18.

TABLE 3

| | first | Second | First | Second |
|---|---|---|---|---|
| | throttle | throttle | valve | valve |
| | valve (11) | valve (12) | (24) | (25) |
| Back-Flush of the second filter | open | closed or | close | open |
| element 2, first filter element | | nearly | | |
| 1 in operation | | closed | | |

FIG. 19 shows the back-flushing of the first 1 and of the second filter element 2. Circulation of raw material is maintained to carry away the removed deposition into concentrate flow.

The following table (Table 4) shows the position of the valves during the back-flushing of the first 1 and of the second 2 filter element while circulation of the fluid in the space between the two filter element is maintained to carry away the removed particle into the concentrate flow. The direction of the filtrate during this operation is indicated by arrows in FIG. 19.

TABLE 4

| | First | Second | First | Second |
|---|---|---|---|---|
| | throttle | throttle | valve | valve |
| | valve (11) | valve (12) | (24) | (25) |
| Back-Flush of the first 1 and of | closed or | closed or | open | open |
| the second filter element 2 | nearly | nearly | | |
| | closed | closed | | |

In all tables the terms “closed or nearly closed” has often been used. This means that the throttle valves at the filtrate harvesting nozzles can be closed without discontinuing the operation of the filtration operation. They also can be nearly closed just for building up the pressure in the corresponding filtrate compartments. As mentioned before, they can also be a common open/close valve.

Although the preferred embodiments of the invention have been disclosed for illustrative purpose, those skilled in the art will appreciate that various modifications, additions or substitutions are possible, without departing from the scope and spirit of the invention as disclosed in the accompanying claims.

### REFERENCE LIST

1. first filter element

2. second filter element

3. housing of the filter element

4. raw material inlet

5. waste or concentrate outlet of the filter unit

6. first filtrate outlet

7. second filter outlet

8. longitudinal axis of the filter unit

9. first filtrate harvesting nozzle

10. second filtrate harvesting nozzle

11. first throttle valve

12. second throttle valve

13. pump

14. first port of the expansion vessel

14′. second port of the expansion vessel

15. first communication nozzle

16. second communication nozzle

17. first expansion vessel

17′. second expansion vessel

18. housing of the first expansion vessel

18′. Housing of the second expansion vessel

19. diaphragm of the first expansion vessel

19′. Diaphragm of the second expansion vessel

20. first compartment of the first expansion vessel

20′. First compartment of the second expansion vessel

21. second compartment of the first expansion vessel

21′. Second compartment of the second expansion vessel

22. valve of the first compartment of the expansion vessel

23. valve of the concentrate or waste outlet

24. first valve of the first communication nozzle

25. second valve of the second communication nozzle

26. three-way connecting means

27. additional valve

28. second filtrate compartment

29. first back-flush nozzle

30. second back-flush nozzle

34. raw material compartment

35. first filtrate compartment

B. back-flush unit

F. filter unit

1. Filter system comprising a back-flush unit (B) connected to a filter unit (F), said back-flush unit (B) being provided to back-flush said filter unit (F),
said filter unit (F) being provided to filter a raw material comprising particles in suspension or in solution in a fluid, said filter unit (F) having at least a housing (3) and at least a first filter element (1) located inside said housing (3), said first filter element (1) separating a raw material compartment (34) from at least a first filtrate compartment (35); both compartments (34,35) being inside said housing (3), said filter unit (F) further having a raw material inlet (4) in communication with said raw material compartment (34) and at least a first filtrate outlet (6) provided to exit a filtrate, said first filtrate outlet (6) being in communication with said first filtrate compartment (35),
said back-flush unit (B) comprising at least a first expansion vessel (17) with a diaphragm (19) provided to divide said expansion vessel (17) into a first compartment (20) and a second compartment (21), said first compartment (20) being provided to contain a compressible medium, said second compartment (21) being provided to contain said filtrate,
said filter system comprising pressurising means (11,12,13,23) to pressurise the filtrate when in the second compartment,
wherein said filter unit further comprises a second filtrate outlet (7) to exit said filtrate, said second filtrate outlet (7) being different and spaced apart from said first filtrate outlet (6), said first filtrate outlet (6) being in communication with said first filtrate compartment (35) and with the second compartment (21) of the expansion vessel (17) by means of a first back-flush nozzle (29), and in wherein said pressurising means (11,12,13,23) are provided to induce a flow rate variation of the filtrate flow rate in said first filtrate compartment (35).

2. Filter system according to claim 1, wherein said pressurising means (12) act at said second filtrate outlet (7) in order to reduce said filtrate flow rate at said second filtrate outlet for filling the expansion vessel.

3. Filter system according to claim 1, wherein said pressurising means (13) act at the raw material inlet in order to induce a raw material flow rate variation inducing said filtrate flow rate variation

4. Filter system according to claim 1, wherein said pressurising means (23) act at an outlet (5) of the filter unit, said outlet being a waste outlet or a concentrate outlet in order to induce a raw material flow rate variation inducing said filtrate flow rate variation.

5. Filter system according to claim 1, wherein said pressurising means (11,12,13,23) comprise a pump.

6. Filter system according to claim 1, wherein said pressurising means (11, 12, 13, 23) comprise a throttle valve.

7. Filter system according to claim 1, wherein said first filtrate outlet (6) is provided upstream the second filtrate outlet (7) relative to a filtrate direction when the filter unit (F) is in filtration operation.

8. Filter system according to claim 1, wherein said filter unit (F) is a cross flow filter unit having a concentrate outlet (5).

9. Filter system according to claim 1, wherein said filter unit (F) is a dead end filter unit.

10. Filter system according to claim 9, wherein said filter unit (F) comprises a waste outlet (5) provided with a valve (23), said waste outlet (5) being provided to remove the particles having a size greater than said predetermined pore size remaining in the raw material compartment (34) when or after back-flushing of the filter unit (F).

11. Filter system according to claim 8, further comprising:
a second filter element (2) installed concentrically inside said first filter element (1) in the filter unit (F) and separating the raw material compartment (34) from a second filtrate compartment (28) being connected to said second filtrate outlet (7),
a second expansion vessel (17′) with a diaphragm (19′) provided to divide said second expansion vessel (17′) into a first compartment (20′) and a second compartment (21′), said first compartment (20′) being provided to contain a compressible medium, said second compartment (21′) being provided to contain said filtrate, said second compartment (21′) of said second expansion vessel (17′) being provided to be connected to said second filtrate outlet (7) by means of a second back-flush nozzle (30),
a first filtrate harvesting nozzle (9) connected to the first filtrate outlet (6), and being in communication with both first (29) and second back-flush nozzle (30) respectively by means of a first communication nozzle (15) and of a second communication nozzle (16), both first and second back-flush nozzles (29,30) comprising a valve (24,25).

12. Filter system according to claim 8, further comprising:
a second filter element (2) installed concentrically inside said first filter element (1) in the filter unit (F) and separating the raw material compartment (34) from a second filtrate compartment (28) being connected to said second filtrate outlet (7),
a second expansion vessel (17′) with a diaphragm (19′) provided to divide said second expansion vessel (17′) into a first compartment (20′) and a second compartment (21′), said first compartment (20′) being provided to contain a compressible medium, said second compartment (21′) being provided to contain said filtrate, said second compartment (21′) of said second expansion vessel (17′) being provided to be connected to said second filtrate outlet (7) by means of a second back-flush nozzle (30),
a first filtrate harvesting nozzle (9) connected to the first filtrate outlet (6), and being in communication with the first back-flush nozzle (29),
a second filtrate harvesting nozzle (10) connected to the second back-flush nozzle (30) and to the second filtrate outlet (7).

13. Filter system according to claim 8, further comprising:
a second filter element (2) installed concentrically inside said first filter element (1) in the filter unit (F) and separating the raw material compartment (34) from a second filtrate compartment (28) being connected to said second filtrate outlet (7),
a first filtrate harvesting nozzle (9) connected to the first filtrate outlet (6), and being in communication with the first back-flush nozzle (29) by means of a first communication nozzle (15),
a second communication nozzle (16) connected to said second filtrate outlet (7) and to the second compartment (21) of the first expansion vessel (17) by means of the first back-flush nozzle (29), both first and second communication nozzle (15,16) comprising a valve (24,25), and
a second filtrate harvesting nozzle (10) connected to said second filtrate outlet (7) and to said second communication nozzle (16).

14. Filter system according to claim 13, wherein said second communication nozzle (16) is connected to said second compartment (21) of said expansion vessel (17) by means of a second back-flush nozzle (30).

15. Filter system according to claim 10, wherein said first filtrate harvesting nozzle (9) comprises said pressurising means (11), being in particular a first throttle valve (11).

16. Filter system according to claim 15, wherein said second filtrate harvesting nozzle (10) comprises said pressurising means (12), being in particular a second throttle valve (12).

17. Filter system according to claim 16, wherein the pressurising means (11,12) of the first and the second filtrate harvesting nozzles (9,10) are separately controlled.

18. Filter system according to claim 25, wherein the valve (24,25) of the first and the second communication nozzles (15,16) are separately controlled.

19. Filter system according claim 18, wherein said concentrate outlet (5) is connected to the raw material inlet (4).

20. Filter system according to claim 19, wherein said concentrate outlet (5) is provided with a valve (23), in particular a throttle valve (23).

21. Filter system according to claim 20, wherein said raw material inlet (4) comprises a three-way-connecting means (26) having a first end, a second end and a third end, the first end being connected to the filter unit (F) and the second end being connected to a raw material tank.

22. Filter system according to claim 21, wherein said pump (13) comprises the three-way-connecting means (26).

23. Filter system according to claim 21, wherein said pump (13) is connected to said first end of the three-way-connecting means (26).

24. Filter system according to claim 23, wherein said third end is a draw off outlet.

25. Filter system according to claim 11, wherein the valve (24,25) of the first and the second communication nozzles (15,16) are separately controlled.
